(19) United States
(12) Patent Application Publication
(10) Pub. No.: US 2009/0024664 A1
(43) Pub. Date: Jan. 22, 2009

(54) Method and system for generating a content-based file, and content-based data structure

(76) Inventor: Alberto Benbunan Garzon, Madrid (ES)

Correspondence Address: COLLARD & ROE, P.C., 1077 NORTHERN BOULEVARD, ROSLYN, NY, 11576, US

(21) Appl. No.: 12/215,523

(22) Filed: Jun. 27, 2008

Related U.S. Application Data
(60) Provisional application No. 60/937,828, filed on Jun. 29, 2007.

(51) Int. Cl. G06F 17/30

(52) U.S. Cl. 707/104.1; 707/E17.009

(57) ABSTRACT

A method for generating a content-based file to be distributed to a mobile device, the content-based file being based on multimedia data and a mechanism for generating a user interface, from the multimedia data, to be shown on the mobile device, includes the steps of determining the type of the mobile device, selected from a set of types of mobile devices, obtaining the technical features associated to the determined mobile device type, adapting the multimedia data and the mechanism for generating the user interface according to the obtained technical features, and generating the content-based file from the adapted multimedia data and the adapted mechanism for generating the user interface. A system generates a content-based file suitable for carrying out such a method and a content-based data structure is distributed for this system.

### CROSS REFERENCE TO RELATED APPLICATIONS

Applicant claims priority under 35 U.S.C. §119(e) of U.S. Provisional Application No. 60/937,828 filed Jun. 29, 2007.

### BACKGROUND OF THE INVENTION

1. Field of the Invention

The present invention relates to a method for generating a content-based file to be distributed to a mobile device, said content-based file being based on multimedia data and means for generating a user interface, from the multimedia data, to be showed on the mobile device. More specifically, the invention relates to a method for generating a content-based file that comprises the needed data for showing, on the mobile device, the user interface associated to said content-based file, said needed data being adapted to the technical features of the mobile device.

The invention also relates to a system for generating a content-based file suitable for carrying out such a method and a content-based data structure to be distributed for said system.

2. The Prior Art

The increased penetration of mobile devices (e.g. cellular phones or personal data assistants (PDA)) and the development of Wireless Application Protocols (WAP) have given way to a multitude of possibilities for new mobile/wireless services.

According to a recent report of Gartner Group, 40% of world population will have got a mobile device in 2009. Approximately, the fifth part of said population has downloaded contents in his mobile device (e.g. addresses, weather information, stock exchange quotes, and any other information) and it is possible that this percentage increases next years.

One of the main challenges for the mobile devices is the small screen and numeric keypad layout. The physical limitations of typical mobile devices impose additional constraints to usability, particularly when compared to traditional computer environments.

Another challenge, probably the most important one, is the maximum size of the files that the mobile devices can process. Nowadays, the performance levels offered by the mobile devices have limitations in processing power and memory and, consequently, the size of the files that can be processed is small.

For this reason, at present, the user interfaces based on content-based files show external links to the data that must be shown in said user interfaces, so that the data is not contained in the content-based file and, consequently, the size of the files is reduced. Obviously, the use of said external link requires, for viewing or reading the user interfaces, connections to external data providers (for example, the establishment of connections through internet between the mobile devices and said data providers) which involve important economical costs to the user. On the other hand, not always is possible to establish a connection between the mobile device and the server, for example, when the mobile device is out of coverage of the wireless network.

The international patent application (PCT) WO 01/93097 of Nokia Corporation, with title “System and method for content adaptation and pagination based on terminal capabilities”, describes a system, method and computer program for paginating information received from a content provider so that it may be showed on any type of user terminal having any size screen and having different types of mechanisms for input the information. The system has a pagination and terminal adaptation module which will calculate the space needed by the element to be showed on a user terminal. Said module will then determine if sufficient space exists on the user terminal screen to show the element. When sufficient space does not exist, the cited module will resize the element when possible in order to make it fit and access a database of user terminal profile information to determine the characteristics of the user terminal as well as the screen size.

Said system has several disadvantages. Firstly, the user terminal (i.e. the mobile device) requires connections (for example, through internet) with the content provider for obtaining the information (i.e. multimedia data). On the other hand, said information is adapted in the user terminal, which involves important problems due to the limitations of the user terminals in the processing power and memory (the mobile device must spend processing resources for adapting the information).

### SUMMARY OF THE INVENTION

It is therefore an object of the invention to provide a method for generating a content-based file which, once has been downloaded on the mobile device, not need external connections.

This object is achieved in accordance with claim 1 by providing a method for generating a content-based file to be distributed to a mobile device, said content-based file being based on multimedia data and means for generating a user interface, from the multimedia data, to be showed on the mobile device, the method comprising the steps of (A) determining the type of the mobile device, selected from a set of types of mobile devices; (B) obtaining the technical features associated to the determined mobile device type; (C) adapting the multimedia data and the means for generating the user interface according to the obtained technical features; (D) generating the content-based file from the adapted multimedia data and the adapted means for generating the user interface.

In this way, it is obtained a content-based file which comprise data adapted to determined technical features of the mobile device (e.g. the data is adapted to the maximum size of a file to be processed) to which the file will be distributed, so that it is possible to add all needed data (multimedia data, code, etc.) for showing the user interface, based on the content-based file, on the mobile device. Thus, external connections are not required. The content-based file may be downloaded on the mobile device and the user interface based on said file may be read or viewed without using external connections (i.e. offline navigation). Consequently, it is possible to read or view the user interface in places in which the mobile device is out of coverage of the wireless network (for example, in the tube or in an underground place).

Another advantage of the invention is that the mobile device does not need to spend processing resources because the data is externally adapted.

It is important to highlight that the content-based file may be a JAR (Java ARchive) file. In this way, Java is used in technical applications and not only in the development of games.

Further, the method may comprise a step (E) of obtaining at least one circumstantial feature and, in step (C), the multimedia data and the means for generating the user interface are adapted according to the obtained technical features and the obtained circumstantial feature.

In a preferred embodiment of the invention, the technical features of the mobile device are selected from the following set of features: size of the screen, resolution of the screen, MIDP (Mobile Information Device Profile) version, WMA (Wireless Messaging API) support or maximum size of a file to be processed by the mobile device.

According to another aspect of the invention, it is provided a computer program comprising program instructions for causing a computer to perform the method for generating a content-based file. Said computer program may be embodied on storing means (for example, on a record medium, on a computer memory or on a read-only memory) or carried on a carrier signal (for example, on an electrical or optical carrier signal).

According to another aspect, the invention provides a system for generating a content-based file to be distributed to a mobile phone, said content-based file being based on multimedia data and means for generating a user interface, from the multimedia data, to be showed on the mobile device, the system comprising means for determining the type of the mobile device, selected from a set of types of mobile devices; means for obtaining the technical features associated to the determined mobile device type; means for adapting the multimedia data and the means for generating the user interface according to the obtained technical features; and means for generating the content-based file from the adapted multimedia data and the adapted means for generating the user interface.

According to yet another aspect of the invention, it is provided a method for distributing a content-based file to a mobile device, said content-based file being based on multimedia data and means for generating a user interface, from the multimedia data, to be showed on the mobile device, the method comprising the steps of (F) receiving a request of download of the content-based file from the mobile device; (A) determining the type of the mobile device, selected from a set of types of mobile devices, based on the request of download; (B) obtaining the technical features associated to the determined mobile device type; (C) adapting the multimedia data and the means for generating the user interface, according to the obtained technical features; (D) generating the content-based file based on the adapted multimedia data and the adapted means for generating the user interface; (G) allowing downloading the content-based file from the mobile device.

It is important to highlight that the steps of the described method may be executed in different order. For example, the steps (A), (B), (C) and (D) may be executed before step (F), that is, the system may generate the content-based file for each type of mobile device in the beginning and store said file in a database. Then, the files are ready to be downloaded from the mobile phones.

Further, the method may comprise the step (E) of obtaining at least one circumstantial feature based on the request of download and, in step (D), the multimedia data and the means for generating the user interface are adapted according to the obtained technical features and the obtained circumstantial feature.

Said circumstantial feature may be, for example, the time in which the request of download is received (e.g. multimedia data relating to said time may be add to the content-based file), the mobile phone operator (e.g. a communication of said operator may be add to the file), or the geographical zone from which the request of download is received (e.g. a multimedia data relating to said zone may be add to the file).

According to another embodiment of the invention, the method comprises a step (H) of sending a communication to the mobile device about the availability of the content-based file. Said communication may comprise a link to the content-based file for doing a request of download, from the mobile device, of said content-based file.

In this way, the user may know when the file is ready and do a request of download of said file acting on the cited link. Said action on the link allows obtaining the circumstantial feature described above and the type of the mobile device.

On the other hand, the communication may be a “WAP-Push” message with a link, where the user may download the based-content file.

According to another aspect, the invention provides a computer program comprising program instructions for causing a computer to perform the method for distributing a content-based file to a mobile device.

According to yet another aspect of the invention, it is provided a system for distributing a content-based file to a mobile device, said content-based file being based on multimedia data and means for generating a user interface, from the multimedia data, to be showed on the mobile device, the system comprising means for receiving a request of download of the content-based file from the mobile device; means for determining the type of the mobile device, selected from a set of types of mobile devices, based on the request of download; means for obtaining the technical features associated to the determined mobile device type; means for adapting the multimedia data and the means for generating the user interface according to the obtained technical features; means for generating the content-based file based on the adapted multimedia data and the adapted means for generating the user interface; means for allowing downloading the content-based file from the mobile device.

According to another aspect, the invention provides a content-based data structure stored in a computer readable medium, which comprises a multimedia section comprising multimedia data and a code section comprising means for generating a user interface (from the multimedia data) to be showed on a mobile device.

In this way, the data structure comprises the whole data to create the user interface to be shown on the mobile device. The expression “whole data” relates to the data (e.g. multimedia data) that must be shown by the user interface, and the data (e.g. the code for paginating the multimedia data) required for generating the user interface.

Further, the data structure may comprise a reader section comprising means for showing the user interface on the mobile device. These means for showing the user interface allow showing said user interface in any mobile device because said means are adapted to the mobile device type.

### BRIEF DESCRIPTION OF THE DRAWINGS

In the following detailed description of some possible embodiments, other features and advantages of the invention will appear, each description being made with reference to the following drawings:

FIG. 1 is a schematic diagram illustrating all the elements involve in the generation and distribution of a content-based file;

FIG. 2 is a flow chart illustrating the method for generating a content-based file, according to the invention;

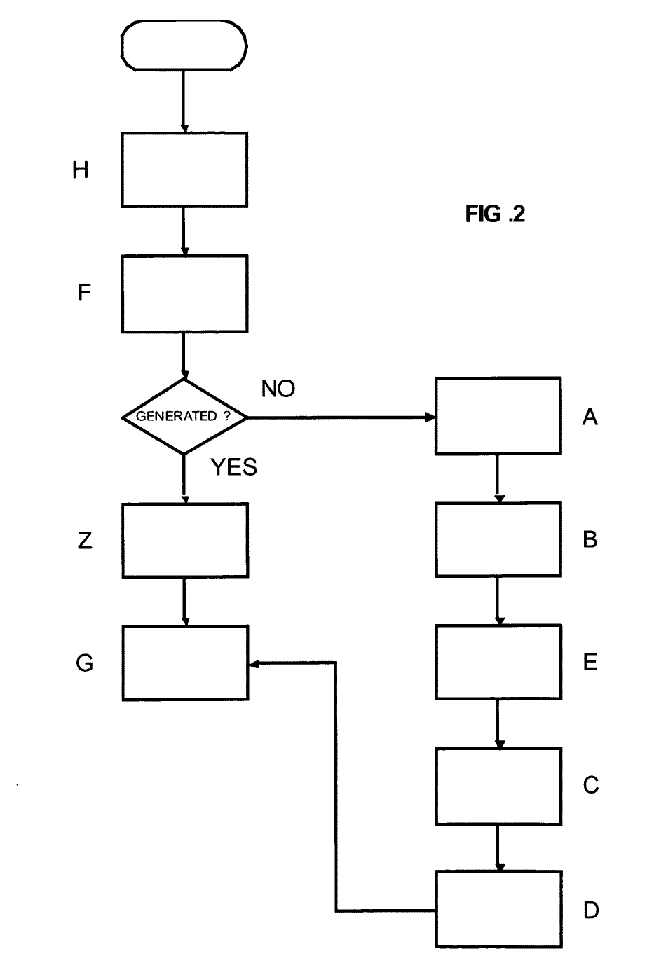

FIG. 3 is a schematic diagram illustrating the user interface based on a content-based file.

### DETAILED DESCRIPTION OF PREFERRED EMBODIMENTS

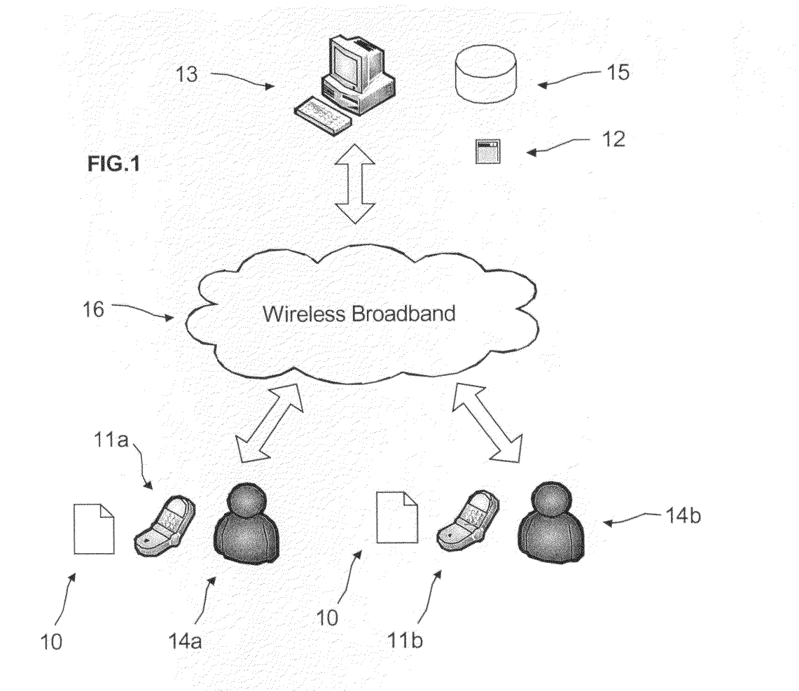

Following, a description of a preferred embodiment of the invention will be described according to the drawings. In said preferred embodiment, as can be seen in FIG. 1, the content-based file is a JAR (Java ARchive) file 10; the mobile devices are mobile phones 11a,11b; the system for distributing the content-based file is a computer program 12 running on a server computer 13; and the system for generating the content-based file 10 is a module of said computer program 12 for distributing the content-based file (obviously, said system could be another computer program or have any other form). The server computer 13 and the mobile phones 11a, 11b connects through a wireless broadband 16 (for example, WiFi, Bluetooth, or UMTS), for distributing the content-based file 10, that is, the connection is established through mobile internet.

JAR files are packaged with the ZIP file format, so it is possible to use them for tasks such as lossless data compression, archiving, decompression, and archive unpacking. To perform basic tasks with JAR files, it is required to use the Java™ Archive Tool provided as part of the Java Development Kit. The JAR file is similar to an “exe” file and the data is accessed by the mobile device. Further, each JAR file is adapted to operate on the corresponding type of mobile devices. In summary, the JAR file is downloaded on the mobile device, through WAP, Web or Bluetooth, and installed on it through JAD (Java Application Descriptor) file, which works like an installer to mobile devices.

More specifically, in the preferred embodiment, the content-based file is the precursor of a daily mobile Java [J2ME] edition of a newspaper that the users 14a, 14b (subscribers) download into their mobile phones 11a, 11b. This edition contains the most relevant news of the printed edition. The format is similar to a newspaper in that the content is presented in consecutive screens as if they were pages in a newspaper. The news items are presented through headlines that function as hyperlinks to access the rest of content. Further, it is possible to insert advertising, for example, in full page format.

The content-based file comprises all needed data to generate the user interface of the newspaper edition, said needed data including multimedia data (video, text, animations, pictures, etc.), means for generating the user interface from said multimedia data, and means for showing said user interface on the mobile phone 11a; 11b. In this way, no external connections are required for viewing or reading the user interface of the newspaper edition. The means for generating the user interface and the means for showing the user interface comprise code (program instructions) adapted to the profile of the type of the mobile device. In summary, the means for generating the user interface are code to paginate the multimedia data and obtain the user interface. The means for showing the user interface on the mobile device also comprise code that reads the user interface and shows it in a linear manner. In both cases, the code runs on the mobile device.

Basically, a picture may be adapted in its size based in the compression, the colours and the background of the picture to maintain its appearance without losing the proportion. The pictures can be adapted for all types of mobile devices because each type has a different size of the screen and a maximum size of the file that may be processed, said file comprising the multimedia data, the means for generating the user interface, from the multimedia data, and the means for showing said user interface on the mobile device. Then, preferably, a picture may be adapted according the screen size and the maximum size of the file that may be processed. On the other hand, it is possible to obtain the most used colour in the picture to be used it in the background of the user interface.

It is important to highlight that the multimedia data, the means for generating the user interface and the means for showing the user interface are always externally adapted, that is, said data is adapted in the server computer 13 and, next, added (i.e. encapsulated) to the content-based file 10. In this manner, the mobile device does not need to spend processing resources for adapting the data; only need resources for paginating the data and generating the user interface (by the means for generating the user interface) to be showed on the mobile device.

The server computer 13 comprises a database 15 of types of mobile devices, each type of mobile device having associated their technical features, such as the screen size, the resolution size, MIDP (Mobile Information Device Profile) version, WMA (Wireless Messaging API) support or the maximum size of a file that the mobile device can process.

The computer program 12 for distributing the content-based file 10 (i.e. a JAR file) comprises a module for sending a communication to the mobile device 11a; 11b about the availability of the content-based file, said communication comprising a link to said content-based file; a module for receiving a request of download of the content-based file 10 from the mobile phone 11a; 11b; a module for determining the type of the mobile device, selected from a set of types of mobile devices, based on the request of download; a module for obtaining the technical features associated to the determined mobile device type; a module for obtaining at least one circumstantial feature based on the request of download; a module for adapting the multimedia data, the means for generating the user interface according to the obtained technical features and the obtained circumstantial feature, and the means for showing the user interface; a module for generating the content-based file 10 based on the adapted multimedia data, the adapted means for generating the user interface, and the adapted means for showing the user interface; and a module for allowing downloading the content-based file from the mobile device 11a; 11b.

Consequently, the module for generating the content-based file comprises the module for determining the type of the mobile device, selected from a set of types of mobile devices, based on the request of download; the module for obtaining the technical features associated to the determined mobile device type; the module for obtaining at least one circumstantial feature based on the request of download; the module for adapting the multimedia data, the means for generating the user interface according to the obtained technical features and the obtained circumstantial feature, and the means for showing the user interface; and the module for generating the content-based file 10 based on the adapted multimedia data, the adapted means for generating the user interface, and the adapted means for showing the user interface.

According to the description of the computer program 12 for distributing a content-based file to a mobile phone, the method that may be performed from said computer program will be described.

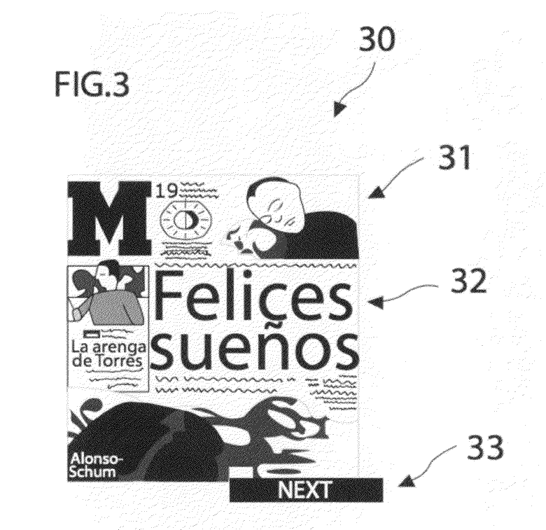

As can be seen in FIG. 3, beginning the method in a step in which the mobile phone 11a; 11b are ready to receive the content based file 10, in a step (H), the module for sending a communication to the mobile device 11a; 11b about the availability of the content-based file sends a “WAP-Push” message with a link, where the user 14a; 14b may download the file and, in a step (F), the module for receiving a request of download receives a request of download of the content-based file 10 from the mobile phone 11a; 11b. Said content-base file may be previously generated or may be generated when the module for receiving a request of download of the content-based file 10 from the mobile phone 11a; 11b receives a request of download.

If the content-based file 10 has been previously generated (for example, for each type of mobile device), in a step (G), the module for allowing downloading the content-based file from the mobile phone 11a; 11b, allows to download the file 10, said content-based file being stored in a database which may be the same one that the database 15 of mobile device types.

In this case, the method for generating the content-base file comprises the following steps. In a step (A), the module for determining the type of the mobile device determines the type of the mobile device to which the mobile phone belongs. Next, in a step (B), the module for obtaining the technical features of the mobile device type obtains the technical features from the database 15 of mobile device types and, in a step (C), the module for adapting the multimedia data, the means for generating the user interface according to the obtained technical features, and the means for showing the user interface, adapts the multimedia data, the means for generating the user interface and the means for showing said user interface. Finally, in a step (D), the module for generating the content-based file 10 generates the content-based file from the adapted multimedia data, the adapted means for generating the user interface 30, and the adapted means for showing the user interface.

If the content-based file does not have been previously generated, then it must be generated. In this case, in the step (A), the module for generating the content-based file determines the type of the mobile phone, selected from a set of types of mobile devices, based on the request of download. Next, in the step (B), the module for obtaining the technical features of the mobile device type obtains the technical features associated to the determined mobile phone type from the technical features database 15 and, in a step (E), the module for obtaining a circumstantial feature obtains one circumstantial feature based on the request of download. Next, in the step (C), the module for adapting the multimedia data, the means for generating the user interface according to the obtained technical features, and the means for showing the user interface adapts the multimedia data, the means for generating the user interface, and the means for showing the user interface according to the obtained technical features and the obtained circumstantial feature and, in the step (D), the module for generating the content-based file generates the content-based file 10 based on the adapted multimedia data, the adapted means for generating the user interface, and the adapted means for showing the user interface.

Said circumstantial feature is obtained from the request of download. The module for receiving the request of download from the mobile phone may obtain, for example, the time in which the request of download is sent, the zone from which the request of download is sent, or the mobile phone operator associated to the mobile phone.

In case of the time, it is possible to add multimedia data adapted to said time. For example, if the request of download is sent at lunch time, it is possible to add advertising of a determined restaurant.

In case of the zone, it is also possible to add multimedia data adapted to said zone. For example, if the request of download is sent from a zone near a theatre, it is possible to add advertising of said theatre or news about it.

In case of the operator, it is also possible to add multimedia data adapted to said operator. For example, it is possible to add advertising of said operator, such as a special offer.

Finally, in the step (G), the module for allowing downloading allows to download the file 10 from the mobile phone 11a; 11b.

Once the content-based file 10 has been downloaded, the user 14a; 14b may view or read the content offline. The content appears in consecutive screens/pages. The first one may present a screenshot of the front page of the newspaper on which the user interface is based. The next page may provide general instructions on how to proceed and the third page may show the newspaper's editorial page. The following pages may present list of news headlines. Users 14a, 14b click on the headlines to access a summary of the news article.

In summary, the content-based file may be read or viewed offline because all the data are contained in the file.

FIG. 3 illustrates an example of user interface from a content-based file. Said user interface 30 comprises pictures 31, text 32, and control elements 33 for navigation through the user interface. Said control elements may be accessed by determined keys of the mobile device keyword. Said keys may be different for each type of mobile device.

The navigation through the user interface is linear with different content levels. Each page may show a single piece, a picture, headlines or a combination of these. The navigation may be done using the keys of the mobile device keyword.

On the other hand, external links may be shown in the user interface, for example, a message, a call or a web/wap url.

A method for creating a JAD file may comprise the calculation of the content-based file (10) version, the content-based file (10) name, and some technical features associated to the determined mobile device type and the classes structure.

A method for creating a JAR file may comprise the packing of the adapted multimedia data and the means into a JAR file which will be executed in the mobile device.

A method for creating the MANIFEST file may comprise the calculation of the content-based file (10) version, the content-based file (10) name, and some technical features associated to the determined mobile device type and the classes structure.

Although the present invention has been described in detail for purpose of illustration, it is understood that such detail is solely for that purpose, and variations can be made therein by those skilled in the art without departing from the scope of the invention.

Thus, while the preferred embodiments of the methods and of the systems have been described in reference to the environment in which they were developed, they are merely illustrative of the principles of the invention. Other embodiments and configurations may be devised without departing from the scope of the appended claims.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

What is claimed is:

1. A method for generating a content-based file (10) to be distributed to a mobile device (11a; 11b), said content-based file (10) being based on multimedia data and means for generating a user interface (30), from the multimedia data, to be showed on the mobile device (11a; 11b), the method comprising the steps of:
A) Determining the type of the mobile device, selected from a set of types of mobile devices;
B) Obtaining the technical features associated to the determined mobile device type;
C) Adapting the multimedia data and the means for generating the user interface according to the obtained technical features;
D) Generating the content-based file (10) from the adapted multimedia data and the adapted means for generating the user interface (30).

2. A method according to claim 1, further comprising a step (E) of obtaining at least one circumstantial feature and, in step (C), the multimedia data and the means for generating the user interface (30) are adapted according to the obtained technical features and the obtained circumstantial feature.

3. A method according to claim 1, wherein the technical features of the mobile device (11a; 11b) are selected from the following set of features: size of the screen, resolution of the screen, MIDP (Mobile Information Device Profile) version, WMA (Wireless Messaging API) support, or maximum size of a file to be processed by the mobile device.

4. A computer program comprising program instructions for causing a computer to perform the method according to claim 1.

5. A computer program according to claim 4, embodied on storing means.

6. A computer program according to claim 4, carried on a carrier signal.

7. A system for generating a content-based file (10) to be distributed to a mobile device (11a; 11b), said content-based file (10) being based on multimedia data and means for generating a user interface (30), from the multimedia data, to be showed on the mobile device, wherein the system comprises means for determining the type of the mobile device (11a; 11b), selected from a set of types of mobile devices; means for obtaining the technical features associated to the determined mobile device type; means for adapting the multimedia data and the means for generating the user interface (30) according to the obtained technical features; and means for generating the content-based file (10) from the adapted multimedia data and the adapted means for generating the user interface.

8. A method for distributing a content-based file (10) to a mobile device (11a; 11b), said content-based file (10) being based on multimedia data and means for generating a user interface (30), from the multimedia data, to be showed on the mobile device (11a; 11b), the method comprising the steps of:
F) Receiving a request of download of the content-based file (10) from the mobile device (11a; 11b);
A) Determining the type of the mobile device, selected from a set of types of mobile devices, based on the request of download;
B) Obtaining the technical features associated to the determined mobile device type;
C) Adapting the multimedia data and the means for generating the user interface (30) according to the obtained technical features;
D) Generating the content-based file (10) based on the adapted multimedia data and the adapted means for generating the user interface;
G) Allowing downloading the content-based file (10) from the mobile device (11a; 11b).

9. A method according to claim 8, further comprising the step (E) of obtaining at least one circumstantial feature based on the request of download and, in step (D), the multimedia data and the means for generating the user interface are adapted according to the obtained technical features and the obtained circumstantial feature.

10. A method according to claim 8, further comprising a step (H) of sending a communication to the mobile device (11a; 11b) about the availability of the content-based file (10).

11. A method according to claim 10, wherein the communication about the availability of the content-based file (10) comprises a link to the content-based file for doing a request of download, from the mobile device, of said content-based file.

12. A method according to claim 9, wherein the circumstantial feature based on the request of download is selected from the following set of features: time in which the request of download is received or geographical zone from which the request of download is received.

13. A computer program (12) comprising program instructions for causing a computer to perform the method according to claim 8.

14. A system for distributing a content-based file (10) to a mobile device (11a; 11b), said content-based file (10) being based on multimedia data and means for generating a user interface (30), from the multimedia data, to be showed on the mobile device, wherein the system comprises means for receiving a request of download of the content-based file (10) from the mobile device (11a; 11b); means for determining the type of the mobile device, selected from a set of types of mobile devices, based on the request of download; means for obtaining the technical features associated to the determined mobile device type; means for adapting the multimedia data and the means for generating the user interface (30) according to the obtained technical features; means for generating the content-based file (10) based on the adapted multimedia data and the adapted means for generating the user interface; means for allowing downloading the content-based file from the mobile device (11a; 11b).

15. A content-based data structure (10) stored in a computer readable medium, wherein the structure comprises a multimedia section comprising multimedia data and a code section comprising means for generating a user interface (30), from the multimedia data, to be showed on a mobile device (11a; 11b).

16. A data structure according to claim 15, further comprising a reader section comprising means for showing the user interface (30) on the mobile device (11a; 11b).
